(19) United States
(12) Patent Application Publication
(10) Pub. No.: US 2016/0260020 A1
(43) Pub. Date: Sep. 8, 2016

(54) METHOD OF SEMANTIC DATA STRUCTURE GENERATING AND METHOD OF SEARCHING AGAINST THE STRUCTURE, AND SYSTEM FOR IMPLEMENTATION THEREOF

(71) Applicant: OBSHESTVO S OGRANICHENNOJ OTVETSTVENNOSTYU "SDI RESEARCH", Moscow (RU)

(72) Inventor: Andrey Nikolaevich Andrichenko, Moscow (RU)

(21) Appl. No.: 14/654,566

(22) PCT Filed: Sep. 24, 2014
(86) PCT No.: PCT/RU2014/000715

§ 371 Date: Jul. 17, 2015

(30) Foreign Application Priority Data
Dec. 23, 2013 (RU) 2013157046

(51) Int. Cl. G06N 5/04; G06F 17/30; G06N 99/00

(52) U.S. Cl. CPC G06N 5/046; G06N 99/005; G06F 17/30598

(57) ABSTRACT

The invention relates to machinery production, namely, selection and determination of compatibility of material and technical objects interacting at various stages of their life cycle as follows: design, operation, repair, transportation, disposal, etc.

The technical effect being achieved by using this invention is improvement of speed and accuracy of determination of compatibility of material and technical objects interacting within various production processes: design, operation, repair, transportation, disposal, etc.

### FIELD

This invention relates to machinery production, namely, selection and determination of compatibility of material and technical objects interacting at various stages of their life cycle as follows: design, operation, repair, transportation, disposal, etc.

### PRIOR ART

Today at manufacturing enterprises a wide range of software and hardware-software complexes are used solving various informational, organizational and process tasks, namely: CAD, ERP, PLM, etc.

These concepts are described below.

CAD, or Computer-Added Design system, is an automated system implementing an information technology of design functions' fulfillment, and represents an organizational and technical system for design process automation, and consists of personnel and package of technical, software and other means of personnel activities' automation. CAE abbreviation is also widely used to designate such systems.

ERP, or Enterprise Resource Planning, is an organizational strategy of production and operations integration, labour management, financial management and asset management, oriented to consistent balancing and optimization of enterprise resources by means of dedicated integrated application software package ensuring common data&process model for all areas of activity. ERP system is a particular software package implementing the ERP strategy.

Product Lifecycle Management (PLM) is a technology for product life cycle management. It represents an organizational and technical system ensuring management of all data and processes related to the product throughout its life cycle starting from design and manufacturing till decommissioning. In this context, a product means different complex technical objects (vessels and vehicles, aircraft and rockets, computer networks and so on). Information about the facility contained in the PLM system is a digital mock-up of this facility.

Manufacturing enterprises implementing information technologies face a problem of duplication of reference databases from various providers such as ERP, PLM, CAD and others. The solution is to separate reference data from applications, centralize such data and align terms (thesaurus) based on ontological data models. The above can be done by using of a system approach to creating of common information space at the enterprise ensuring implementation of the common corporate language for automated systems' communication called MDM, or Master Data Management (management of master data or main data).

Master data management, main data management constitutes the set of processes and tools for continuous identification and management of company's main data (including reference data).

Master data is the data representing information critical for the company or business, for example: information about clients, products, services, personnel, technologies, materials and so on. Such data is changed on relatively rare occasions and is not transactional.

There exists also the MDM sort called PIM class systems (MDM for PIM/Product Information Management) such as Oracle Product Hub, IBM Infosphere MDM Product Hub, SAP MDM. These systems are for centralized management of reference product data (Product Information Management). Such systems allow ensuring of uniform standardized representation of information about company's products due to which different information subsystems of the enterprise can communicate information represented in a common format.

Presently, the most promising trend of growth for MDM systems is application of semantic technologies that makes them more efficient if used for engineering data handling.

Semantic technologies are based on the semantic network concept. Semantic network is the domain area informational model represented in the form of a directed graph nodes of which correspond to the domain objects and arcs (edges) specify relations between them. The objects may be concepts, events, properties, or processes. Therefore, semantic network is one of knowledge representation methods. In the semantic network, nodes are represented by database concepts, and arcs (oriented) specify relations between them. Therefore, semantic network expresses the domain area semantics in the form of concepts and relations.

Use of semantic technologies as part of hardware-software complexes allow “conscious” searching of objects involving both parameters of the target object and rules of its interaction with other objects. Integration of semantic MDM and CAE gives the possibility to promote automation of decision-making during designing of new products.

The technical solution is known described in the application for USA patent No US 2013/0117325 dated 9 May 2013, “Semantically Related Objects”, Robert Heidasch. According to an aspect of the invention, the method for use of a semantic network metamodel is described. By this method, a company's data metamodel is generated. The metamodel gives semantic information on a particular business object. The metamodel is used to generate rules reflecting corporate data on semantic objects and semantic relations between them. In some embodiments, such rules may be used to generate semantic objects and semantic relations with data extracted from the company data. Semantic objects and semantic relations are saved in the semantic network metamodel.

The main disadvantage of this method and system is that semantic relations are only set up between semantic objects that eliminates the possibility to consider relations between the objects in the context of the certain process due to which this solution can not be used for optimal selection of material and technical objects required for the given production process.

Another technical solution is known described in patent #EP 2562695A2, dated 27 Feb. 2013, “Self-Learning Semantic Search System”, Robert Heidasch. The method, machine-readable medium and the system to provide the self-learning semantic search engine. A semantic network can be created in an initial configuration. A search engine in the semantic network can create indices and semantic indices. Business data can be obtained at user's request. A search system can be available via a semantic dispatcher. Based on the access, the search system can update the indices and semantic indices.

The disadvantage of this technical solution is the lack of a semantic models' configuration tool. Thus, there is no concept of knowledge domain modelling that as well eliminates the possibility to use this solution for selection and identification of material and technical objects required for the given production process.

### SUMMARY

Existing MDM systems for PIM and intended for centralized management of product reference data including reference books and classifiers of equipment, tools, etc. store reference descriptions of objects, allow classification of these and monitoring of changes introduced. In industrial production, all objects such as materials, parts, equipment, tools, jigs, and fixtures, etc. are interacting continuously. MDM systems for PIM presently available in the market do not deal with issues related to description of rules for interaction of such objects in the context of different points of view on the objects by certain dedicated experts: designers, production engineers, service technicians, accountants, etc.

This invention is aimed at elimination of disadvantages inherent in the existing solutions.

The technical effect being achieved by using this invention is improvement of speed and accuracy of determination of compatibility of material and technical objects interacting within various production processes: design, operation, repair, transportation, disposal, etc.

Using of the concept “process” allows introducing of a context component when dealing with objects. In this process, context representation of the object internal structure (components (parts) and “visible” attributes) changes dynamically depending on the processes participated in. This allows considering of objects from various points of view. For example, a production engineer shall see in the metal-cutting machine the mechanisms of workpiece and cutting tool transfer, and a machine engineer shall see units and parts subject to preventive maintenance. From the context point of view, relations between objects are also considered.

Let us consider generating of semantic data structure ensuring the possibility to use a context component when dealing with objects.

The method of semantic data structure generating includes the following steps in the given order:
Objects and processes' classification is formed with distinguishing of at least one component the object consists of, in each object category; such component comprises at least a component identifier and one or more attributes characterizing this component;
The relation is formed between each object component and one or more processes the component participates in;
For each process, all object pairs related to this process are identified between which the relation is formed that determines the rules of interaction of the said objects within the said process.

The rules of interaction of the said objects within the said process are established in the form of mathematical and logical operations.

The rules for interaction of the said objects within the said process are established in the form of mathematical and logical operations in scripting languages.

This method can be implemented in the hardware-software complex described below.

The system for semantic data structure generating including:
a. one or more processors;
b. one or more data storage devices;
c. one or more programs;
   wherein one or more programs are stored on one or more data storage devices and are being executed on one or more processors, and one or more programs comprise the following instructions:
      objects and processes' classification is formed with distinguishing of at least one component the object consists of, in each object category; such component comprises at least a component identifier and one or more attributes characterizing this component;
      the relation is formed between each object component and one or more processes the component participates in;
      for each process, all object pairs related to this process are identified between which the relation is formed that determines the rules of interaction of the said objects within the said process.

The system for semantic data structure generating, wherein the rules for interaction of the said objects within the said process are established in the form of mathematical and logical operations.

The system for semantic data structure generating wherein the rules for interaction of the said objects within the said process are established in the form of mathematical and logical operations in scripting languages.

Let us consider the method and the system for semantic data structure generating in question in further detail:

Objects and processes are classified by categories in this domain area. Components of each object are distinguished, if possible. Each object component is given the attributes.

Then, from the host of object components stable groups are formed characterizing the object in the context of particular processes. Each group includes object components related to particular process. The same object component can be related to one or several processes.

Therefore, each technician can consider material objects in the desired dedicated context (process) as follows: repair, operation, transfer, disposal etc. The object's context manages the components' structure (i.e., finally, the composition of attributes) and relations of this object with other objects at a particular moment of its life cycle. In a wide sense, the structure of each object is only considered from the point of view of activity level of this particular object, i.e. those actions (processes) this object participates in. We can say that the structure of an object is determined by possible operations that can be made with it.

Information about the objects' compatibility is entered into the database. The compatibility rules are distributed according to the classification hierarchy down to object instances and their components. The rules belong to two relation types: object-object and component-component. Each rule must be connected with particular context (process), i.e. it must be context-process-dependable. Finally, a semantic network is formed that determines interrelations and compatibilities of the objects attributed to different categories. Compatibility of two objects within such network will be determined exclusively in the context of a particular process by aggregate compatibility of their components attributed to this process.

Thus, an object can have several internal states-structures, each of which can be related to one or several processes. To determine compatibility of two objects, firstly it shall be determined within which process they interact, then the relevant object structures shall be selected and only after that the possibility of compatibility of a pair of objects shall be checked based on the compatibility of their components.

Let us further consider the method of objects' searching in a semantic data structure.

The method of objects' searching in a semantic data structure includes the following steps in the given order:
The category of the target object is obtained, as well as the process the target object participates in, and associated objects participating in this process;
All objects in the target object's category are selected containing at least one component related to the above mentioned process;
Among the objects selected at the previous step, ones are selected which components are compatible with the components of associated objects based on the compatibility rules in force in the context of the above mentioned process.

The method of objects' searching in the semantic data structure can be implemented with the following modification:
1. at the first step, parameters of the target object are additionally obtained including at least one attribute;
2. after performing of the main steps, objects are additionally selected that correspond to the parameters of the target object.

This method of searching can be implemented in a semantic data structure generated using the method described above.

This method can be implemented on a hardware-software complex (platform)

The system for objects' searching in a semantic data structure including:
a. one or more processors;
b. one or more data storage devices;
c. one or more programs;
   wherein one or more programs are stored on one or more data storage devices and are being executed on one or more processors, and one or more programs comprise the following instructions:
      the category of the target object is obtained, as well as the process the target object participates in, and associated objects participating in this process;
      all objects in the target object's category are selected containing at least one component related to the above mentioned process;
      among the objects selected at the previous step, ones are selected which components are compatible with the components of associated objects based on the compatibility rules in force in the context of the above mentioned process.

The system for objects' searching in the semantic data structure can also be implemented with the following modification:
a. at the first step, parameters of the target object are additionally obtained including at least one attribute;
b. after performing of the main steps, objects are additionally selected that correspond to the parameters of the target object.

The system for objects' searching in the semantic data structure, wherein the search is done against the semantic data structure generated using the system described above.

Let us consider the above method and system for objects' searching in a semantic data structure in further detail.

The following search criteria are given to input: type of target object and its particular parameters (if any), title of process and associated objects available that participate in this process together with the target object. The process and associated objects in this case acts as filters limiting the target object search area. The semantic searching algorithm is as follows:

Objects having the component group related to the mentioned process are searched for in the classifier the target object belongs to. Among the objects selected, ones are searched for that are compatible with the associated objects given to input within the mentioned process. The objects' compatibility is determined via compatibility of their components belonging to the same group in the context of the given process. Then, the global search is performed among the remaining objects by the target object given parameters.

The semantic search will result in selection of a limited group of objects that has passed two filtering stages: searching by compatibility with associated objects in the context of the given process and searching by the target object given parameters. This search engine allows significant reduction of the target solution area.

### DESCRIPTION OF THE DRAWINGS

FIG. 1 shows a hierarchy diagram of classes included into classifiers of tools and metal-cutting machines. The objects are connected by association classes determining the compatibility rules. Relations between the objects, in turn, are taken over from the processes. To determine compatibility of a pair of objects, one shall check fulfillment of conditions of a set of rules located in the class hierarchy.

### DESCRIPTION OF THE PREFERRED EMBODIMENT(S)

Suppose a production engineer at a machine-building enterprise is given the following task: to develop the plan for axial hole machining in a box-shaped workpiece of a hard alloy metal. The initial data are as follows:
type, material and dimensions of the workpiece;
type, accuracy parameters, roughness and overall dimensions of the surface being machined (structural element—SE);

Let us assume that the production engineer has already selected the equipment that is upright drilling machine 2H135. Now, he has to determine which cutting tool will be used for the hole machining.

The cutting tool classifier contains several types of tools that can be used for holes finishing: drills, multi flute drills, reamers, broaches, cutters, and end mills. Firstly, the cutting tool of the required type shall be selected. Within the range of this type of, e.g. drill, several hundreds of drill types are contained for different materials such as: metal, wood, concrete, etc.

Drills are also classified by the following types: twist drills, spade drills, gun drills an so on. All drills have different connecting part (shank: that can be cone-shaped, cylindrical, hexagonal, etc.) that determines the possibility to install a drill on one or another equipment type.

In this case, the only selection are drills for hard-alloy metals with connecting part of the type that is compatible with the mounting seat for cutting tools on the machine 2H135. Dimensions of this drill shall correspond with the SE dimensions, and the cutting tool overall dimensions shall not exceed the overall dimensions of the machine working area with due account for the box-shaped workpiece installed. The cutting instrument classifier contains several drills of this type. It is required the system automatically selects only these types of drills from the cutting tools classifier.

The task is formulated as follows: under given initial conditions (workpiece type: case with known overall dimensions, workpiece material: hard alloy metal, machine model: 2H135, hole of given diameter D, L and surface quality), only those types of cutting tools shall be selected from the cutting tools electronic classifier that are compatible with the listed objects, i.e. semantic, “conscious” searching of objects shall be performed using both parameters of the target cutting tool object (cutting tool diameter shall correspond to the SE diameter) and the rules of its compatibility with other objects being the material and the machine.

One of stages of the task solving is generating of semantic data structure using the method described below.

The method of semantic data structure generating includes the following steps in the given order:
Objects and processes' classification is formed with distinguishing of at least one component the object consists of, in each object category; such component comprises at least a component identifier and one or more attributes characterizing this component;
The relation is formed between each object component and one or more processes the component participates in;
For each process, all object pairs related to this process are identified between which the relation is formed that determines the rules of interaction of the said objects within the said process.

The method of semantic data structure generating, wherein the rules for interaction of the said objects within the said process are established in the form of mathematical and logical operations.

The method of semantic data structure generating wherein the rules for interaction of the said objects within the said process are established in the form of mathematical and logical operations in scripting languages.

This method can also be implemented in the hardware-software complex disclosed below.

The system for semantic data structure generating includes:

a. one or more processors;
b. one or more data storage devices;
c. one or more programs;
wherein one or more programs are stored on one or more data storage devices and are being executed on one or more processors, and one or more programs comprise the following instructions being executed in the specified order:
   objects and processes' classification is formed with distinguishing of at least one component the object consists of, in each object category; such component comprises at least a component identifier and one or more attributes characterizing this component;
   the relation is formed between each object component and one or more processes the component participates in;
   for each process, all object pairs related to this process are identified between which the relation is formed that determines the rules of interaction of the said objects within the said process.

The system for semantic data structure generating, wherein the rules for interaction of the said objects within the said process are established in the form of mathematical and logical operations.

The system for semantic data structure generating wherein the rules for interaction of the said objects within the said process are established in the form of mathematical and logical operations in scripting languages.

Let's us consider the steps described in the method and system in further detail. It is necessary to:
1. Construct classification of the technical objects as follows: machines, cutting tools, materials, etc. Assign attributes to each object and allocate them to a particular object component.
2. Distribute attributes and components by contexts. The object's context manages the structure of the attributes, structure of the components and relations of the given object in a particular period of its life cycle. Thus, a production engineer, a designer, an accountant, a procurement officer shall only see the attributes required for him, i.e. in own context. For example, an accountant is not interested in characteristics of the cutting edge and connecting part of the cutting tool.
3. Introduce information on compatibility of various objects in the form of rules representing the combination of no matter how complex mathematical operations and logical conditions. For example:
   a) A compatibility rule for a rotary cutting tool and metal-cutting machine: Morse taper of machine's mounting seat must be equal to Morse taper of the cutting tool connecting part as follows:
   Machine.Mounting_seat.Morse_taper=Tool.Connecting_part.Morse_taper, where “Machine” is the object, “Mounting_seat” is the component, and “Morse_taper” is the attribute.
   b) A compatibility rule for a workpiece and turning machine: A workpiece can be mounted in the machine's working space if its length is less than centre-to-centre distance of the machine and the workpiece radius is less than the height of the machine centres as follows:
   (Machine.Working_space.Height_of_centers_over_bed>0.5*Workpiece.Diameter) AND (Machine.Working_space.Centre-to-centre_distance>Workpiece.Length)

The rule can be developed in a scripting language, for example, VBScript, JavaScpipt, with the use of any logical and mathematical operations.

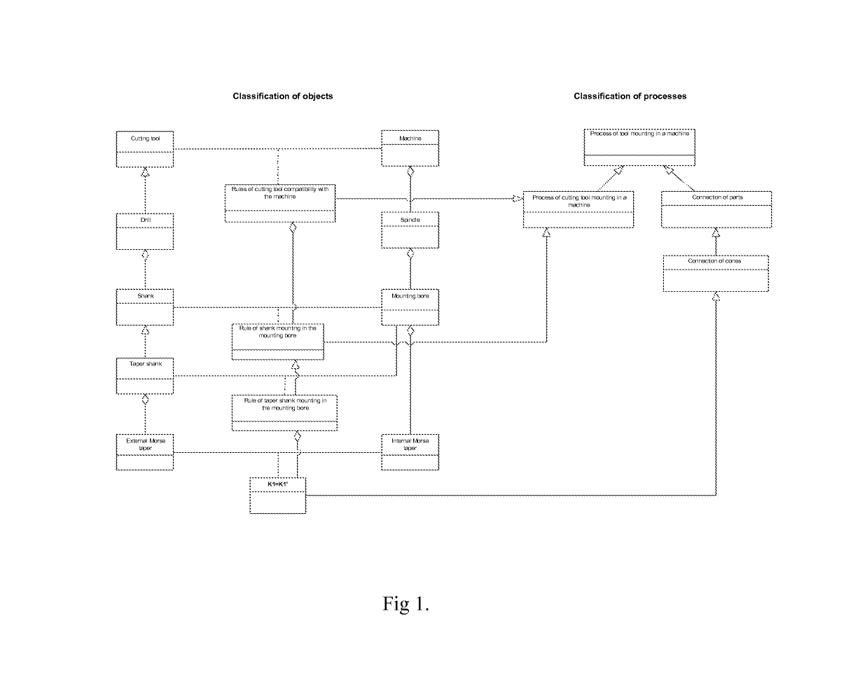

Rules only involve components and attributes of objects that are “visible” in the context of the given process. The compatibility rules are distributed along to the classification hierarchy down to object components (FIG. 1).

Compatibility of two objects is determined as compatibility of their components. Thus, the compatibility of a cutting tool and a metal-working machine is determined by a set of rules of different level: whether this type of cutting tool is compatible with this machine type, whether the machine mounting seat type is compatible with the cutting tool connecting part, whether installation of a particular cutting tool is possible in the working space of the certain machine, whether parameters of the cutting tool connecting part correspond to the machine mounting seat parameters.

Compatibility rules shall belong to particular contexts, i.e. they shall be context-dependable. Thus, the compatibility rules shown on the diagram shall be activated only in the context (process)—“cutting tool operation \ mounting in the machine chuck”.

Finally, a semantic network is formed that determines interrelations and compatibility of different objects contained in various classification groups.

Compatibility of two objects within such network is determined by compatibility of their components belonging to contexts (processes) of the same name.

Let us assume that all necessary information on classifications, attributes, contexts and interrelations of the objects has already been entered into the MDM system database.

To perform an object search in a semantic data structure the following steps in the given order shall be done:
The category of the target object is obtained, as well as the process the target object participates in, and associated objects participating in this process;
All objects in the target object's category are selected containing at least one component related to the above mentioned process;
Among the objects selected at the previous step, ones are selected which components are compatible with the components of associated objects based on the compatibility rules in force in the context of the above mentioned process.

The following modification of this method is available:
1. at the first step, parameters of the target object are additionally obtained comprising at least one attribute;
2. after performing of the main steps, objects are additionally selected that correspond to the parameters of the target object.

According to the methods described, the searching can be performed against the data structure generated using the method described above.

This method can be implemented in the hardware-software complex described below.

The system for objects' searching in a semantic data structure including:
a. one or more processors;
b. one or more data storage devices;
c. one or more programs;
   wherein one or more programs are stored on one or more data storage devices and are being executed on one or more processors, and one or more programs comprise the following instructions being executed in the specified order:
      the category of the target object is obtained, as well as the process the target object participates in, and associated objects participating in this process;
      all objects in the target object's category are selected containing at least one component related to the above mentioned process;
      among the objects selected at the previous step, ones are selected which components are compatible with the components of associated objects based on the compatibility rules in force in the context of the above mentioned process.

The system for objects' searching in the semantic data structure can be implemented with the following modification:
a. at the first step, parameters of the target object are additionally obtained comprising at least one attribute;
b. after performing of the main steps, objects are additionally selected that correspond to the parameters of the target object.

The system for objects' searching in the semantic data structure, wherein the search is done against the data structure generated by the system for semantic data structure generating described above.

Let us consider how this method, or the system implementing the method, works using an example.

The following objects are transferred to MDM system input: machine 2H135, structural element shall be hole of known dimensions, material shall be hard alloy metal, workpiece of box-shaped type with specified overall dimensions. The MDM system uses these objects as filters when entering the cutting tools' classifier. Firstly, all tools compatible with machine 2H135, material and structural element (hole) are selected in the cutting tools' classifier. Then, from remaining ones, those are selected the hole diameter of which is equal to the tool diameter. Finally, we will obtain the sample of several types of cutting tools suitable for the given conditions.

If we want to install a cutting tool in the machine dispenser for storage, the compatibility of the machine and cutting tool must be considered in the context of another process which is “cutting tool operation \ mounting in machine dispenser”. In this case, other rules of compatibility determination for these two objects will be involved that are related to other components (dimensions of the cutting tool and machine dispenser cell).

Use of this invention under production conditions allows, but not limited to, repeated improvement of speed and accuracy of determination of compatibility of material and technical objects interacting within various production processes.

We claim:

1. The method of semantic data structure generating comprising the following steps:
Objects and processes' classification is formed with distinguishing of at least one component the object consists of, in each object category; such component comprises at least a component identifier and one or more attributes characterizing this component;
The relation is formed between each object component and one or more processes the component participates in;
For each process, all object pairs related to this process are identified between which the relation is formed that determines the rules of interaction of the said objects within the said process.

2. The method of semantic data structure generating of claim 1, wherein the rules for interaction of the said objects within the said process are established in the form of mathematical and logical operations.

3. The method of semantic data structure generating of claim 1, wherein the rules for interaction of the said objects within the said process are established in the form of mathematical and logical operations in scripting languages.

4. The method of objects' searching in a semantic data structure comprising the following steps:
The category of the target object is obtained, as well as the process the target object participates in, and associated objects participating in this process;
All objects in the target object's category are selected containing at least one component related to the above mentioned process;
Among the objects selected at the previous step, ones are selected which components are compatible with the components of associated objects based on the compatibility rules in force in the context of the above mentioned process.

5. The method of objects' searching in a semantic data structure of claim 4, wherein
a. at the first step, parameters of the target object are additionally obtained comprising at least one attribute;
b. after performing of the main steps, objects are additionally selected that correspond to the parameters of the target object.

6. The method of objects' searching in the semantic data structure of claim 4, wherein the search is done against the data structure generated using the method of claim 1

7. The method of objects' searching in the semantic data structure of claim 5, wherein the search is done against the data structure generated using the method of claim 1

8. The system for semantic data structure generating comprising:
a. one or more processors;
b. one or more data storage devices;
c. one or more programs;
wherein one or more programs are stored on one or more data storage devices and are being executed on one or more processors, and one or more programs comprise the following instructions being executed in the specified order:
objects and processes' classification is formed with distinguishing of at least one component the object consists of, in each object category; such component comprises at least a component identifier and one or more attributes characterizing this component;
the relation is formed between each object component and one or more processes the component participates in;
for each process, all object pairs related to this process are identified between which the relation is formed that determines the rules of interaction of the said objects within the said process.

9. The system for semantic data structure generating of claim 8, wherein the rules for interaction of the said objects within the said process are established in the form of mathematical and logical operations.

10. The system for semantic data structure generating of claim 8, wherein the rules for interaction of the said objects within the said process are established in the form of mathematical and logical operations in scripting languages.

11. The system for objects' searching in a semantic data structure comprising:
a. one or more processors;
b. one or more data storage devices;
c. one or more programs;
wherein one or more programs are stored on one or more data storage devices and are being executed on one or more processors, and one or more programs comprise the following instructions being executed in the specified order:
the category of the target object is obtained as well as the process the target object participates in, and associated objects participating in this process;
all objects in the target object's category are selected containing at least one component related to the above mentioned process;
among the objects selected at the previous step, ones are selected which components are compatible with the components of associated objects based on the compatibility rules in force in the context of the above mentioned process.

12. The system for objects' searching in a semantic data structure of claim 11, wherein
a. at the first step, parameters of the target object are additionally obtained comprising at least one attribute;
b. after performing of the main steps, objects are additionally selected that correspond to the parameters of the target object.

13. The system for objects' searching in the semantic data structure of claim 11, wherein the search is done against the data structure generated using the system of claim 8
